(19) United States
(12) Patent Application Publication
(10) Pub. No.: US 2025/0245811 A1
(43) Pub. Date: Jul. 31, 2025

(54) WELDING INSPECTION APPARATUS AND WELDING INSPECTION METHOD

(71) Applicant: SK On Co., Ltd., Seoul (KR)

(72) Inventors: Hyo Sung HONG, Daejeon (KR); Seung Won LEE, Daejeon (KR); Yoon Sung OH, Daejeon (KR); Jae Hun KIM, Daejeon (KR)

(21) Appl. No.: 19/033,498

(22) Filed: Jan. 22, 2025

(30) Foreign Application Priority Data
Jan. 26, 2024 (KR) 10-2024-0012397

(51) Int. Cl. G06T 7/00; G06V 10/80

(52) U.S. Cl. CPC G06T 7/0006; G06V 10/803; G06T 2207/30136

(57) ABSTRACT

A welding inspection apparatus of the present disclosure includes a scanner configured to acquire a two-dimensional image and a three-dimensional image by photographing a battery, a data processor configured to generate fusion data based on the two-dimensional image and the three-dimensional image, an object identifier configured to identify a welding area in the fusion data based on an artificial intelligence model trained to identify an object, and a welding determiner configured to determine whether a weld joint of the battery is defective based on the welding area.

### CROSS-REFERENCE TO RELATED PATENT APPLICATION

The present application claims priority under 35 U.S.C. § 119(a) to Korean patent application number 10-2024-0012397 filed on Jan. 26, 2024, in the Korean Intellectual Property Office, the entire disclosure of which is incorporated by reference herein.

### BACKGROUND OF THE INVENTION

### 1. Field

Embodiments of the present disclosure relate to a secondary battery, and specifically, to a welding inspection apparatus and a welding inspection method.

### 2. Description of the Related Art

Recently, secondary batteries may be reused multiple times through charging and discharging. The secondary batteries are widely used in various industries due to their economical and eco-friendly characteristics. A welding process may be performed to manufacture a battery. An apparatus and a method for accurately inspecting welding defects of the battery are required.

### SUMMARY OF THE INVENTION

Embodiments of the present disclosure provide a welding inspection apparatus and a welding inspection method to inspect welding defects of a battery.

The present disclosure may be widely applied in the field of green technology such as solar power generation and wind power generation. In addition, the present disclosure may be applied to eco-friendly devices such as electric vehicles and hybrid vehicles to prevent climate change by suppressing air pollution and greenhouse gas emissions.

A welding inspection apparatus according to an embodiment of the present disclosure includes a scanner configured to acquire a two-dimensional image and a three-dimensional image by photographing a battery, a data processor configured to generate fusion data based on the two-dimensional image and the three-dimensional image, an object identifier configured to identify a welding area in the fusion data based on an artificial intelligence model trained to identify an object, and a welding determiner configured to determine whether a weld joint of the battery is defective based on the welding area.

In an embodiment, the three-dimensional image may include a plurality of pixels, a first height value within a first bit unit being mapped to each of the plurality of pixels, and the two-dimensional image may include a plurality of pixels, a first luminance value within a second bit unit being mapped to each of the plurality of pixels.

In an embodiment, the data processor may be configured to perform resizing to reduce the number of pixels of the two-dimensional image and the three-dimensional image and generate the fusion data using the resized two-dimensional image and the resized three-dimensional image.

In an embodiment, the data processor may be configured to generate the fusion data by using a second luminance value obtained by normalizing the first luminance value and a second height value obtained by normalizing the first height value.

In an embodiment, the data processor may be configured to perform a weighted operation on the second luminance value and the second height value corresponding to each other to generate the fusion data.

In an embodiment, each of the second luminance value and the second height value may be a value within a third bit unit smaller than the first bit unit and the second bit unit.

In an embodiment, the second height value may be proportional to a ratio of a first difference value between the first height value and a set lower limit value of the first height value and a second difference value between a set upper limit value of the first height value and the set lower limit value.

In an embodiment, the second height value may be a value obtained by multiplying the ratio by a maximum value within a third bit unit smaller than the first bit unit.

In an embodiment, the set upper limit value may be a value obtained by adding a first set value to a middle value of the first height value of each of the plurality of pixels included in the three-dimensional image, and the set lower limit value may be a value obtained by subtracting a second set value from the middle value.

In an embodiment, the second luminance value may be proportional to a ratio of the first luminance value and a value obtained by adding 1 to a maximum value of the second bit unit.

In an embodiment, the second luminance value may be a value obtained by multiplying the ratio by a maximum value within a third bit unit smaller than the second bit unit.

In an embodiment, the welding area may include a bead area, and the welding determiner may be configured to determine whether the weld joint is defective according to whether the bead area exists in a preset region of interest.

In an embodiment, the welding area may further include an emboss area, and the region of interest may be the emboss area.

In an embodiment, the welding area may include a bead area, and the welding determiner may be configured to determine whether the weld joint is defective according to a length of the bead area.

In an embodiment, the welding determiner may be configured to determine whether the weld joint is defective according to the first height value of the three-dimensional image corresponding to the bead area.

A welding inspection method according to an embodiment of the present disclosure may include photographing a battery to acquire a two-dimensional image and a three-dimensional image, generating fusion data based on the two-dimensional image and the three-dimensional image, identifying a welding area in the fusion data based on an artificial intelligence model trained to identify an object, and determining whether a weld joint of the battery is defective based on the welding area.

In an embodiment, the generating of the fusion data may include performing resizing to reduce the number of pixels of the two-dimensional image and the three-dimensional image, and generating the fusion data using the resized two-dimensional image and the resized three-dimensional image.

In an embodiment, the generating of the fusion data may include acquiring a second luminance value by normalizing a first luminance value mapped to one pixel of a plurality of pixels of the two-dimensional image, and acquiring a second height value by normalizing a first height value of a pixel corresponding to the one pixel of a plurality of pixels of the three-dimensional image, and generating the fusion data by using the second luminance value and the second height value.

In an embodiment, a maximum value of bits having the second height value may be less than a maximum value of bits having the first height value, and a maximum value of bits having the second luminance value may be less than a maximum value of bits having the first luminance value.

In an embodiment, the generating of the fusion data by using the second luminance value and the second height value may include performing a weighted operation on the second luminance value and the second height value to acquire a result value and generating the fusion data including the result value.

An embodiment of the present disclosure may provide a welding inspection apparatus and a welding inspection method to inspect welding defects of a battery.

An embodiment of the present disclosure may provide a welding inspection apparatus and a welding inspection method which are robust to noise.

An embodiment of the present disclosure may provide a welding inspection apparatus and a welding inspection method to accurately inspect the welding defects of the battery.

An embodiment of the present disclosure may provide a welding inspection apparatus and a welding inspection method to quickly inspect the welding defects of the battery.

### BRIEF DESCRIPTION OF THE DRAWINGS

FIG. 1 is a block diagram for illustrating a welding inspection apparatus according to an embodiment.

FIG. 2 is a diagram for illustrating a weld joint of a battery according to an embodiment.

FIG. 3 is a diagram for illustrating a welding inspection method of a welding inspection apparatus according to an embodiment.

FIG. 4 is a diagram for illustrating a process of processing data according to an embodiment.

FIG. 5 is a diagram for illustrating a process of generating fusion data according to an embodiment.

FIG. 6 is a diagram for illustrating normalization of height values and luminance values according to an embodiment.

FIG. 7 is a diagram for illustrating a welding area identified in fusion data according to an embodiment.

### DETAILED DESCRIPTION

The structural or functional descriptions of embodiments disclosed in the present specification or application are merely illustrated for the purpose of explaining embodiments according to the technical principle of the present disclosure, and embodiments according to the technical principle of the present disclosure may be implemented in various forms in addition to the embodiments disclosed in the specification of application. In addition, the technical principle of the present disclosure is not construed as being limited to the embodiments described in the present specification or application.

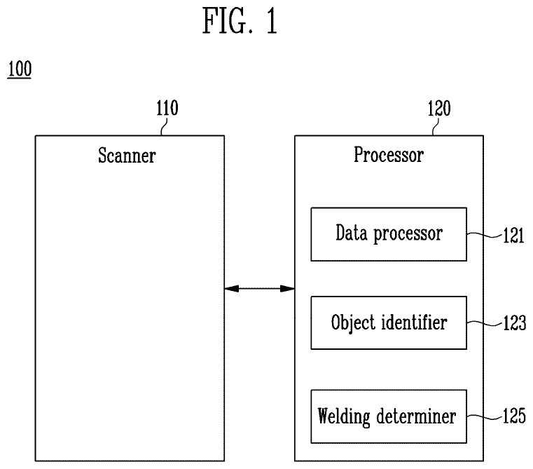

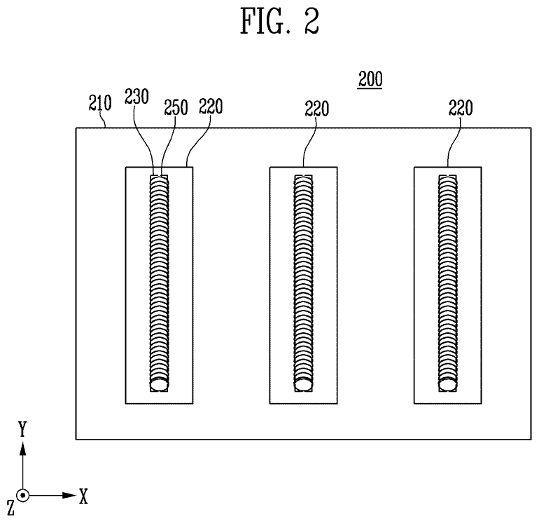

FIG. 1 is a block diagram for illustrating a welding inspection apparatus according to an embodiment. FIG. 2 is a diagram for illustrating a weld joint of a battery according to an embodiment.

Referring to FIGS. 1 and 2, a welding inspection apparatus 100 according to an embodiment may inspect a weld joint 250 of a battery 200. The welding inspection apparatus 100 may determine whether the weld joint 250 of the battery 200 is defective.

The battery 200 may be a secondary battery which can be charged and discharged multiple times. The type of battery 200 may be divided into battery cells, battery modules, and battery packs depending on the unit, and the battery 200 of the present disclosure may be applied to various types without limitation to its type. The battery 200 of FIG. 2 according to an embodiment may be a battery module. The battery module may include a plurality of battery cells and a busbar 210 which electrically connects the plurality of battery cells. In an embodiment, the busbar 210 may include an emboss 220 having a height higher than its surroundings, a slit hole 230 formed by penetrating a portion of the bus bar 210 (or the emboss 220), and the weld joint 250. Here, the height may represent a length in a height direction (e.g., in a Z-axis direction). The emboss 220 may be omitted. The weld joint 250 may be formed by welding while an electrode tab of the battery cell is inserted into the slit hole 230. This is merely an embodiment, and the weld joint 250 may be formed at various locations within the battery 200.

The welding inspection apparatus 100 may include a scanner 110 and a processor 120.

The scanner 110 may acquire a two-dimensional (2D) image and a three-dimensional (3D) image by photographing the battery 200. A photographing area of the scanner 110 may be an area including the weld joint 250 of the battery 200. The two-dimensional image may be data which represents luminance of each location (or coordinates), and the three-dimensional image may be data which represents a height of each location (or coordinates).

The processor 120 may compute and process data. For example, the processor 120 may process the two-dimensional image and the three-dimensional image to determine whether the weld joint 250 is defective. In an embodiment, the processor 120 may include at least one of a digital signal processor (DSP), a microprocessor, a central processing unit (CPU), a graphics processing unit (GPU), an accelerated processing unit (APU), an application processor (AP), a neural processing unit (NPU), and a controller.

In an embodiment, the processor 120 may include a data processor 121, an object identifier 123, and a welding determiner 125. The data processor 121 may generate fusion data based on the two-dimensional image and the three-dimensional image. The object identifier 123 may identify a welding area from the fusion data based on an artificial intelligence (AI) model. Here, the AI model may be pre-trained to identify an object. The welding determiner 125 may determine whether the weld joint 250 is defective based on the welding area.

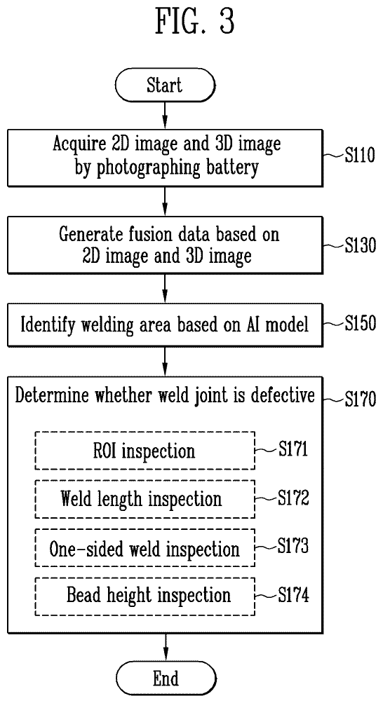

FIG. 3 is a diagram for illustrating a welding inspection method of a welding inspection apparatus according to an embodiment.

Referring to FIGS. 1 to 3, a welding inspection method of the welding inspection apparatus 100 may acquire a two-dimensional image and a three-dimensional image by photographing the battery 200 (S110), generate fusion data based on the two-dimensional image and the three-dimensional image (S130), identify a welding area based on the artificial intelligence model (S150), and determine whether the weld joint 250 of the battery 200 is defective (S170).

In an embodiment, the scanner 110 may acquire the two-dimensional image and the three-dimensional image by photographing the battery 200 (S110). In an embodiment, the scanner 110 may include at least one of an optical scanner, a structured light scanner, or a time-of-flight (ToF) scanner. The optical scanner may acquire the two-dimensional image and/or the three-dimensional image by receiving light rays (e.g., laser, visible light, or infrared light) reflected from a surface of the battery 200. The structured light scanner may acquire the three-dimensional image by irradiating structured light with a specific pattern on a surface of the battery 200 and using the degree of distortion of the pattern of the reflected light. The ToF scanner may acquire the three-dimensional image by using a time difference between the time when a laser is irradiated on a surface of the battery 200 and the time when the laser reflected from the surface of the battery 200 is received. This is merely an embodiment, and the type of scanner 110 is not limited thereto.

In an embodiment, the data processor 121 may generate fusion data (or a fusion image) based on the two-dimensional image and the three-dimensional image (S130). In an embodiment, the data processor 121 may generate the fusion data by performing synthesis of the two-dimensional image and the three-dimensional image. In another embodiment, the data processor 121 may perform preprocessing on at least one of the two-dimensional image and the three-dimensional image and then perform synthesis to generate the fusion data. The preprocessing may include at least one of resizing, normalizing, and bitwise conversion.

In an embodiment, the generating of the fusion data may include performing a resizing process which reduces the number of pixels of the two-dimensional image and three-dimensional image and generating the fusion data using the resized two-dimensional and three-dimensional images.

In an embodiment, the generating of the fusion data may include normalizing a first luminance value mapped to one pixel of a plurality of pixels of the two-dimensional image to acquire a second luminance value, normalizing a first height value of a pixel corresponding to one pixel of a plurality of pixels of the three-dimensional image to acquire a second height value, and generating the fusion data using the second luminance value and the second height value.

In an embodiment, a maximum value of bits having the second height value may be less than a maximum value of bits having the first height value, and a maximum value of bits having the second luminance value may be less than a maximum value of bits having the first luminance value.

In an embodiment, the generating of the fusion data using the second luminance value and the second height value may include performing a weighted operation on the second luminance value and the second height value performed to obtain a result value and generating the fusion data including the result value.

In an embodiment, the object identifier 123 may identify the welding area based on the trained AI model (S150). For example, the AI model may determine a rule (or a pattern) to identify an object by training using large amounts of training data. The trained AI model of the present disclosure may be a pre-trained program to identify an object from input data. The input data may be the fusion data. The AI model of the present disclosure may be trained by the welding inspection apparatus 100 or an external apparatus. In an embodiment, the AI model may be pre-trained by at least one of supervised or unsupervised learning. The supervised learning may be a method of training an artificial intelligence model using input data and label data indicating a correct answer for the input data. For example, the supervised learning may be a method of learning a relationship between data input to and output from an artificial intelligence model so that when the input data is input to an artificial intelligence model, the output data output from the artificial intelligence model is the same as the label data. The unsupervised learning may be a method of training an artificial intelligence model to find patterns from input data without label data and to cluster similar data to make predictions. In an embodiment, the welding inspection apparatus 100 may further include a storage to store the trained AI model.

In an embodiment, the welding determiner 125 may determine whether the weld joint 250 of the battery 200 is defective based on the identified welding area (S170). In an embodiment, the determining of whether the weld joint 250 is defective (S170) may include at least one of region of interest (ROI) inspection (S171), weld length inspection (S172), one-sided weld inspection (S173), and bead height inspection (S174).

In an embodiment, the ROI inspection (S171) may determine whether the weld joint 250 is defective based on whether the welding area identified in the fusion data is present in a preset region of interest. In an embodiment, the welding area may include at least one of a bead area, an emboss area, and a slit hole area. The region of interest may be an area which has a preset size and exists in a preset location in the fusion data. The weld length inspection (S172) may determine whether the weld joint 250 is defective according to whether the length of the bead area identified in the fusion data is within a reference range. The one-sided weld inspection (S173) may determine whether the weld joint 250 is defective according to whether the length of a one-sided area in the bead area identified in the fusion data is within a reference range. The bead height inspection (S174) may determine whether the weld joint is defective according to the first height value of the 3D image corresponding to the bead area identified in the fusion data.

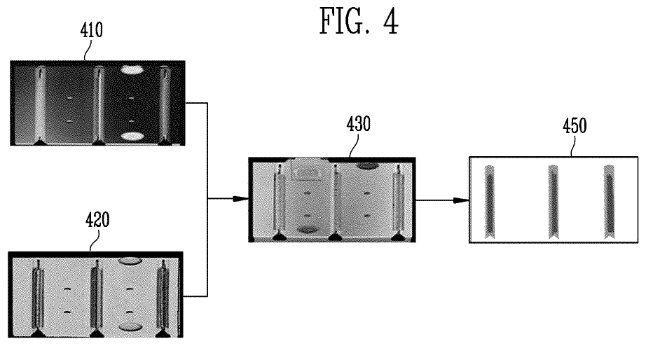

FIG. 4 is a diagram for illustrating a process of processing data according to an embodiment.

Referring to FIGS. 1 and 4, the scanner 110 may acquire a three-dimensional image 410 and a two-dimensional image 420.

In an embodiment, the three-dimensional image 410 may include a plurality of pixels to which first height values within a first bit unit are mapped, respectively. Each of the plurality of pixels may represent a position (or coordinates) on a plane (e.g., an XY plane). For example, each pixel may represent a unique XY coordinate which does not overlap with each other. Each of the plurality of pixels may be mapped to a respective first height value within the first bit unit. For example, a larger first height value may indicate a higher height. The first bit unit may represent the number of bits assigned to a single pixel. For example, if the first bit unit is 16 bits, the first height value may be in the range of 0 to 65535.

In an embodiment, the two-dimensional image 420 may include a plurality of pixels to which first luminance values within a second bit unit are mapped, respectively. Each of the plurality of pixels may represent a position (or coordinates) on a plane (e.g., the XY plane). For example, each pixel may represent a unique XY coordinate which does not overlap with each other. Each of the plurality of pixels may be mapped to a respective first luminance value within the second bit unit. For example, a higher first luminance value may indicate a brighter brightness. The second bit unit may represent the number of bits assigned to a single pixel. For example, if the second bit unit is 10 bits, the first luminance value may be in the range of 0 to 1023.

The data processor 121 may generate fusion data 430 based on the three-dimensional image 410 and the two-dimensional image 420. The fusion data 430 may include a plurality of pixels representing locations (or coordinates) on a plane (e.g., the XY plane). Each pixel of the fusion data 430 may be mapped to a value generated based on the first height value of a corresponding pixel of the three-dimensional image 410 and the first brightness value of a corresponding pixel of the two-dimensional image 420. Here, the corresponding pixels may represent pixels at a same location. For example, the data processor 121 may generate one result value based on the first height value of a pixel corresponding to a specific location in the three-dimensional image 410 and the first brightness value of a pixel corresponding to the same location in the two-dimensional image 420. The data processor 121 may generate the fusion data 430 including respective result values of the plurality of pixels.

The object identifier 123 may input the fusion data 430 to the AI model trained to identify the object, and may acquire output data 450 output from the trained AI model. Here, the object may be a welding area including at least one of the bead area, the emboss area, and the slit hole area. The bead area may be an area representing a weld joint of a battery, the emboss area may be an area representing an emboss of the battery, and the slit hole area may be an area representing a slit hole of the battery. The output data 450 may be an image, but is not limited thereto and may be implemented as various types of data. The output data 450 may include identification information for each of the bead area, the emboss area, and the slit hole area. For example, the identification information may include information such as a boundary, a length, and a location of each of the bead area, the emboss area, and the slit hole area.

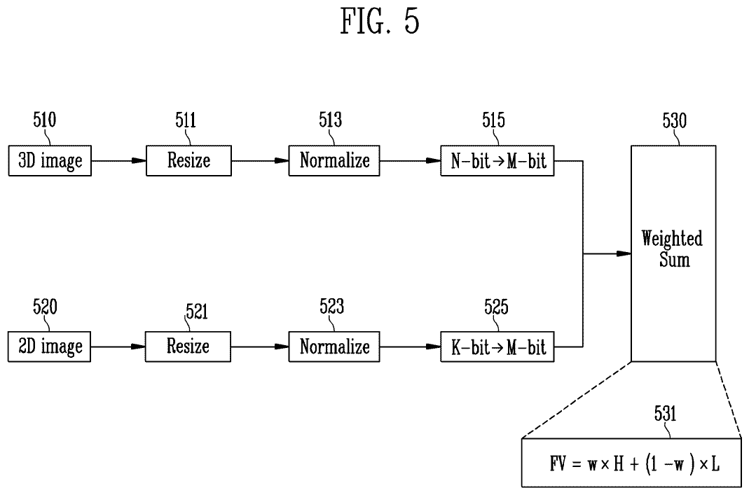

FIG. 5 is a diagram for illustrating a process of generating fusion data according to an embodiment.

Referring to FIGS. 1 and 5, the data processor 121 according to an embodiment may generate the fusion data based on the three-dimensional image 510 and the two-dimensional image 520.

In an embodiment, the data processor 121 may generate the fusion data after performing preprocessing on the three-dimensional image 510 and the two-dimensional image 520. The preprocessing may include at least one of resizing (511, 521), normalizing (513, 523), and bitwise converting (515, 525). The data processor 121 may generate the fusion data by performing a weighted operation 530 for the three-dimensional image and the two-dimensional image on which the preprocessing has been performed. In another embodiment, the data processor 121 may perform the weighted operation 530 on the three-dimensional image 510 and the two-dimensional image 520 without preprocessing.

In an embodiment, the weighted operation 530 may be an operation according to Equation 1 531. Here, H may be a height value mapped to the pixel (e.g., the first height value, the second height value, or the like), L may be a luminance value mapped to the pixel (e.g., the first luminance value, the second luminance value, or the like), and w may be a weight value. w may be a number greater than or equal to 0 and less than or equal to 1. For example, w may be a value of 0.5, 0.4, or the like. FV is a result value mapped to the pixel and may be included in the fusion data. The example described above is merely an embodiment, and the weighted operation 530 may be implemented by being transformed into various mathematical formulas.

In an embodiment, the data processor 121 may perform the resizing (511, 521) to reduce the number of pixels in the three-dimensional image 510 and the two-dimensional image 520. The three-dimensional image 510 may include a plurality of pixels to which the first height value is mapped, and the two-dimensional image 520 may include a plurality of pixels to which the first luminance value is mapped. The sizes of the three-dimensional image and the two-dimensional image on which resizing (511, 521) has been performed may be reduced. The resizing 511 and 521 may be performed using a variety of interpolation algorithms. In an embodiment, each of the three-dimensional image 510 and the two-dimensional image 520 may have a size of 3200×1135. Here, 3200 may be the number of pixels in a horizontal direction (e.g., the X-axis direction), and 1135 may be the number of pixels in a vertical direction (e.g., the Y-axis direction). For example, when the magnification for each of the horizontal and vertical directions of the resizing (511, 521) is 0.4×, each of the 3-dimensional image and the 2-dimensional image subjected to the resizing (511, 521) may have a size of 1280×454. In other words, the number of pixels in each of the horizontal and vertical directions may be reduced. Accordingly, the amount of data to be processed by the welding inspection apparatus 100 may be reduced.

In an embodiment, the data processor 121 may generate the fusion data using the three-dimensional image and the two-dimensional image on which the resizing (511, 521) has been performed. Specifically, the data processor 121 may generate the fusion data by performing the weighted operation 530 for the height value of the three-dimensional image and the luminance value of the two-dimensional image for which the resizing (511, 521) has been performed. For example, the height value and the luminance value mapped to corresponding pixels in the three-dimensional image and the two-dimensional image on which the resizing (511, 521) has been performed may be input into H and L of Equation 1 531 of the weighted operation 530 to generate the fusion data including the result value FV.

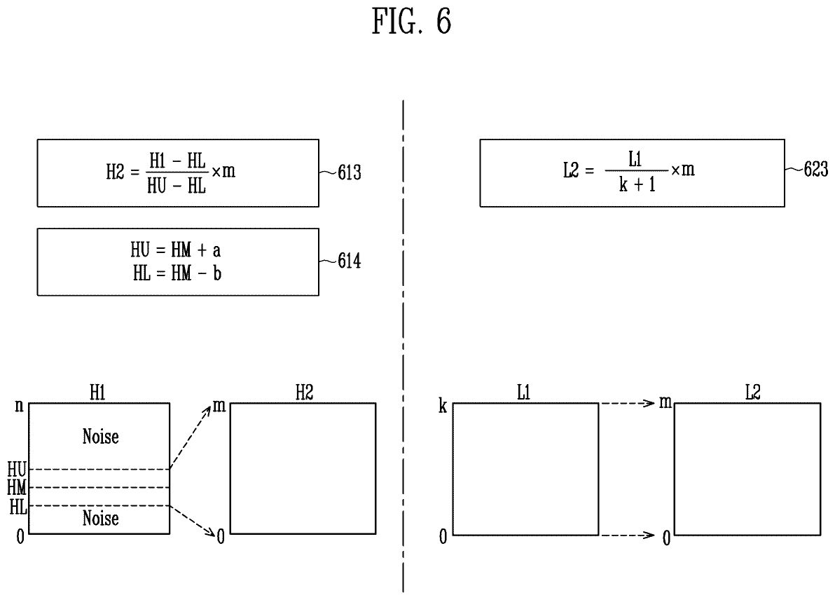

In an embodiment, the data processor 121 may perform the normalizing (513, 523) to change each of the first height value of the three-dimensional image 510 (or the height value of the three-dimensional image on which the resizing 511 has been performed) and the first luminance value of the two-dimensional image 520 (or the luminance value of the two-dimensional image on which the resizing 521 has been performed) to a value within a predetermined range. In this case, the data processor 121 may acquire the second height value by normalizing the first height value and the second luminance value by normalizing the first luminance value. A specific embodiment will be described below with reference to FIG. 6.

In an embodiment, the data processor 121 may generate fusion data using the second height value and the second luminance value obtained by performing the normalizing (513, 523). In an embodiment, the data processor 121 may generate the fusion data by performing the weighted operation 530 for the second luminance value and the second height value corresponding to each other. For example, the data processor 121 may generate the fusion data including the result value FV by inputting the height value and the luminance value mapped to corresponding pixels into H and L of Equation 1 531 of the weighted operation 530.

In an embodiment, the data processor 121 may perform the bitwise converting (515, 525) which changes the bit units of the three-dimensional image 510 (or the three-dimensional image on which the normalizing 513 has been performed) and the two-dimensional image 520 (or the two-dimensional image on which the normalizing 523 has been performed). Here, the bit unit may refer to a representable range of values (or information). For example, if the bit unit is 8 bits, each of the plurality of pixels may be mapped to a value in the range of 0 to 255 (e.g. the height value, the luminance value, or the like). For example, if the bit unit is 16 bits, each of the plurality of pixels may be mapped to a value in the range 0 to 65535 (e.g., the height value, the luminance value, or the like). For 8 bits, the representable range is narrower than that of 16 bits, but data processing time may be reduced. In an embodiment, the second height value and the second luminance value on which the bitwise converting (515, 525) has been performed may be values within a third bit unit.

In an embodiment, first bitwise converting 515 may change the first bit unit of the three-dimensional image 510 (or the 3-dimensional image on which preprocessing (e.g., resizing 511 or normalizing 513) has been performed) into the third bit unit. For example, the first bit unit may be N bits, and the third bit unit may be M bits. Here, N and M are natural numbers, respectively, and N may be greater than M. For example, N may be 16 and M may be 8.

In an embodiment, second bitwise converting 525 may change the second bit unit of the two-dimensional image 520 (or the two-dimensional image on which the preprocessing (e.g., the resizing 521 or the normalizing 523) has been performed) to the third bit unit. For example, the second bit unit may be K bits, and the third bit unit may be M bits. Here, K and M are natural numbers, respectively, and K may be greater than M. For example, K may be 10 and M may be 8. In an embodiment, K may be equal to N, or different from N.

In an embodiment, the data processor 121 may acquire fusion data by performing the weighted operation 530 on the three-dimensional image and the two-dimensional image on which the bitwise converting (515, 525) has been performed.

FIG. 6 is a diagram for illustrating normalization of height values and luminance values according to an embodiment.

Referring to FIGS. 1 and 6, the data processor 121 may acquire the second height value H2 by normalizing the first height value H1 mapped to each of the plurality of pixels included in the three-dimensional image. In an embodiment, the data processor 121 may perform the bitwise converting to change the first bit unit of the second height value H2 to the third bit unit. The third bit unit may be less than the first bit unit. Here, the first bit unit may be N bits, and the third bit unit may be M bits. For example, for N bits, the first height value H1 may be within a range of 0 to n. Here, n may be 2^{N}−1. For example, for M bits, the second height value H2 may be within a range of 0 to m. Here, m may be 2^{M}−1.

In an embodiment, according to Equation 2 613, the second height value H2 may be proportional to the ratio of a first difference value and a second difference value. The first difference value may be a difference value between the first height value H1 and a set lower limit value HL of the first height value H1. The second difference value may be a difference value between a set upper limit value HU and the set lower limit value HL of the first height value H1. In an embodiment, the second height value H2 may be a value obtained by multiplying the ratio of the first difference value and the second difference value multiplied by the maximum value (m) within the third bit unit. For example, if the third bit unit is M bits, the maximum value (m) within the third bit unit may be 2^{M}−1.

In an embodiment, according to Equation 3 614, the set upper limit value HU of the first height value H1 may be a value obtained by adding a first set value (a) to a middle value HM. Here, the middle value HM may be a median value of the first height value H1 of each of the plurality of pixels included in the three-dimensional image. The set lower limit value HL of the first height value H1 may be a value obtained by subtracting a second set value (b) from the middle value HM. The first set value (a) and the second set value (b) may be preset values. In an embodiment, the first set value (a) and the second set value (b) may be a same value or different values.

In an embodiment, the set upper limit value HU of the first height value H1 may be changed to the maximum value (m) in the third bit unit of the second height value H2. The set lower limit value HL of the first height value H1 may be changed to the minimum value (0) of the second height value H2.

In an embodiment, the data processor 121 may acquire the second luminance value L2 by normalizing the first luminance value L1 mapped to each of the plurality of pixels included in the two-dimensional image. In an embodiment, the data processor 121 may perform bitwise converting to change the second bit unit of the second luminance value L2 to the third bit unit. The second bit unit may be less than the first bit unit. Here, the second bit unit may be K bits, and the third bit unit may be M bits. For example, for N bits, the first height value H1 may be within a range of 0 to k. Here, k may be 2^{K}−1. For example, for M bits, the second luminance value L2 may be within a range of 0 to m. Here, m may be 2^{M}−1.

In an embodiment, according to Equation 4 623, the second luminance value L2 may be proportional to the ratio of the first luminance value L1 and the maximum value (k) of the second bit unit plus 1. In an embodiment, the second luminance value L2 may be a value obtained by multiplying the ratio of the first luminance value L1 and the maximum value (k) of the second bit unit plus 1 by the maximum value (m) within the third bit unit.

In an embodiment, the maximum value (k) of the second bit of the first luminance value (L1) may be changed to the maximum value (m) of the third bit unit of the second height value (L2). The minimum value (0) of the first luminance value H1 may be changed to the minimum value (0) of the second height value (H2).

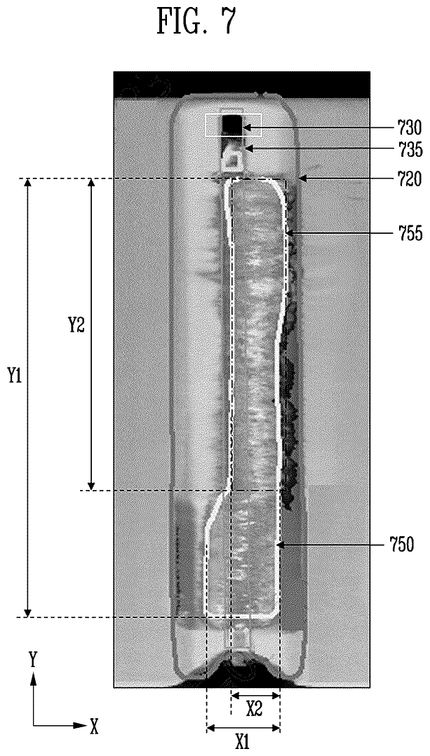

FIG. 7 is a diagram for illustrating a welding area identified in fusion data according to an embodiment.

Referring to FIGS. 1 and 7, the object identifier 123 may identify an object in a welding area from fusion data. In an embodiment, the welding area may include at least one of an emboss area 720, a slit hole area 730, and a bead area 750. The emboss area is an area representing an emboss of a battery, the slit hole area is an area representing a slit hole of the battery, and the bead area 750 may be an area representing a weld joint of the battery.

In an embodiment, the welding determiner 125 may determine whether the weld joint is defective or not based on whether the bead area 750 exists in a preset region of interest. For example, the welding determiner 125 may determine that the weld joint is defective in case that the bead area 750 is absent in the preset region of interest. In an embodiment, the region of interest may be a preset region. For example, the region of interest may be an area which has a preset size in the fusion data and exists in a preset location. In another embodiment, the region of interest may be set to the emboss area 720.

In an embodiment, the welding determiner 125 may determine whether the weld joint of the battery is defective according to a length of the bead area 750. For example, assume that a long side of the weld joint is formed in a vertical direction (e.g., the Y-axis direction).

In an embodiment, the welding determiner 125 may determine whether the weld joint is defective or not according to whether a total length Y1 of the bead area 750 for the vertical direction (e.g., the Y-axis direction) is within a reference range. For example, the welding determiner 125 may determine that the weld joint is defective in case that the total length Y1 of the bead area 750 does not fall within the reference range.

In an embodiment, the welding determiner 125 may determine whether a one-sided area 755 exists in the bead area 750, and determine whether the weld joint is defective based on whether a length Y2 of the one-sided area 755 in the vertical direction (e.g., the Y-axis direction) is within a reference range. For example, the welding determiner 125 may determine, in the bead area 750, an area having a length X2 smaller than a reference value in a total length X1 in a horizontal direction (e.g., the X-axis direction) as the one-sided area 755. For another example, the welding determiner 125 may determine, in the bead area 750, an area which is separated by a reference value or more in the horizontal direction (e.g., the X-axis direction) from the slit hole area 730 (or a guide area 735) as the one-sided area 755. The guide area 735 may be a preset area. For example, the welding determiner 125 may determine that the weld joint is defective in case that the length Y2 of the one-sided area 755 does not fall within the reference range.

In an embodiment, the welding determiner 125 may determine whether the weld joint is defective according to the first height value of a three-dimensional image corresponding to the bead area 750. Here, the first height value may be a height value of the three-dimensional image rather than the fusion data. In an embodiment, the welding determiner 125 may determine whether the weld joint is defective according to whether the first height value is within a reference range. For example, the welding determiner 125 may determine that the weld joint is defective in case that the first height value does not fall within the reference range.

What is claimed is:

1. A welding inspection apparatus comprising:
a scanner configured to acquire a two-dimensional image and a three-dimensional image by photographing a battery;
a data processor configured to generate fusion data based on the two-dimensional image and the three-dimensional image;
an object identifier configured to identify a welding area in the fusion data based on an artificial intelligence model trained to identify an object; and
a welding determiner configured to determine whether a weld joint of the battery is defective based on the welding area.

2. The welding inspection apparatus according to claim 1, wherein the three-dimensional image comprises a plurality of pixels, a first height value within a first bit unit being mapped to each of the plurality of pixels, and
the two-dimensional image comprises a plurality of pixels, a first luminance value within a second bit unit being mapped to each of the plurality of pixels.

3. The welding inspection apparatus according to claim 2, wherein the data processor is configured to perform resizing to reduce the number of pixels of the two-dimensional image and the three-dimensional image and generate the fusion data using the resized two-dimensional image and the resized three-dimensional image.

4. The welding inspection apparatus according to claim 2, wherein the data processor is configured to generate the fusion data by using a second luminance value obtained by normalizing the first luminance value and a second height value obtained by normalizing the first height value.

5. The welding inspection apparatus according to claim 4, wherein the data processor is configured to perform a weighted operation on the second luminance value and the second height value corresponding to each other to generate the fusion data.

6. The welding inspection apparatus according to claim 4, wherein each of the second luminance value and the second height value is a value within a third bit unit smaller than the first bit unit and the second bit unit.

7. The welding inspection apparatus according to claim 4, wherein the second height value is proportional to a ratio of
a first difference value between the first height value and a set lower limit value of the first height value, and
a second difference value between a set upper limit value of the first height value and the set lower limit value.

8. The welding inspection apparatus according to claim 7, wherein the second height value is a value obtained by multiplying the ratio by a maximum value within a third bit unit smaller than the first bit unit.

9. The welding inspection apparatus according to claim 7, wherein the set upper limit value is a value obtained by adding a first set value to a middle value of the first height value of each of the plurality of pixels included in the three-dimensional image, and
the set lower limit value is a value obtained by subtracting a second set value from the middle value.

10. The welding inspection apparatus according to claim 4, wherein the second luminance value is proportional to a ratio of
the first luminance value, and
a value obtained by adding 1 to a maximum value of the second bit unit.

11. The welding inspection apparatus according to claim 10, wherein the second luminance value is a value obtained by multiplying the ratio by a maximum value within a third bit unit smaller than the second bit unit.

12. The welding inspection apparatus according to claim 1, wherein the welding area comprises a bead area, and
the welding determiner is configured to determine whether the weld joint is defective according to whether the bead area exists in a preset region of interest.

13. The welding inspection apparatus according to claim 12, wherein the welding area further comprises an emboss area, and
the region of interest is the emboss area.

14. The welding inspection apparatus according to claim 1, wherein the welding area comprises a bead area, and
the welding determiner is configured to determine whether the weld joint is defective according to a length of the bead area.

15. The welding inspection apparatus according to claim 14, wherein the welding determiner is configured to determine whether the weld joint is defective according to the first height value of the three-dimensional image corresponding to the bead area.

16. A welding inspection method comprising:
photographing a battery to acquire a two-dimensional image and a three-dimensional image;
generating fusion data based on the two-dimensional image and the three-dimensional image;
identifying a welding area in the fusion data based on an artificial intelligence model trained to identify an object; and
determining whether a weld joint of the battery is defective based on the welding area.

17. The welding inspection method according to claim 16, wherein the generating of the fusion data comprises:
performing resizing to reduce the number of pixels of the two-dimensional image and the three-dimensional image; and
generating the fusion data using the resized two-dimensional image and the resized three-dimensional image.

18. The welding inspection method according to claim 16, wherein the generating of the fusion data comprises:
acquiring a second luminance value by normalizing a first luminance value mapped to one pixel of a plurality of pixels of the two-dimensional image, and acquiring a second height value by normalizing a first height value of a pixel corresponding to the one pixel of a plurality of pixels of the three-dimensional image; and
generating the fusion data by using the second luminance value and the second height value.

19. The welding inspection method according to claim 18, wherein a maximum value of bits having the second height value is less than a maximum value of bits having the first height value, and
a maximum value of bits having the second luminance value is less than a maximum value of bits having the first luminance value.

20. The welding inspection method according to claim 18, wherein the generating of the fusion data by using the second luminance value and the second height value comprises performing a weighted operation on the second luminance value and the second height value to acquire a result value and generating the fusion data including the result value.
